(19) United States
(12) Patent Application Publication
(10) Pub. No.: US 2025/0149756 A1
(43) Pub. Date: May 8, 2025

(54) BATTERY CELL AND BATTERY MODULE

(71) Applicant: TOYOTA JIDOSHA KABUSHIKI KAISHA, Aichi-ken (JP)

(72) Inventors: Kota OHATA, Toyota-shi (JP); Masahiro ISHIZUKA, Toyota-shi (JP); Hajime HASEGAWA, Aichi-gun (JP); Mitsuru TATEISHI, Toyota-shi (JP); Norihiro OSE, Nagoya-shi (JP); Masashi CHIHARA, Nagoya-shi (JP)

(21) Appl. No.: 18/932,622

(22) Filed: Oct. 31, 2024

(30) Foreign Application Priority Data
Nov. 8, 2023 (JP) 2023-191007

(51) Int. Cl. H01M 50/553; H01M 50/119; H01M 50/176

(52) U.S. Cl. CPC H01M 50/553; H01M 50/119; H01M 50/176

(57) ABSTRACT

A battery cell includes: a laminate exterior body formed of a laminate containing a metal layer; an electrode body accommodated inside the laminate exterior body, in which electrode body a positive electrode and a negative electrode are laminated with one another sandwiching a separator; a pair of tabs that are connected with, respectively, the positive electrode and the negative electrode and that project outside the laminate exterior body; and a pair of conductive members that are electrically connected with the metal layer and disposed to be separated from the tabs, the conductive members respectively making contact with the pair of tabs in association with a swelling of the laminate exterior body.

### CROSS-REFERENCE TO RELATED APPLICATION

This application is based on and claims priority under 35 USC 119 from Japanese Patent Application No. 2023-191007 filed on Nov. 8, 2023, the disclosure of which is incorporated by reference herein.

### BACKGROUND

### Technical Field

The present disclosure relates to a battery cell and a battery module.

### Related Art

Japanese Patent Application Laid-Open (JP-A) No. 2020-64881 discloses a pouch-form rechargeable battery including an electrode assembly (an electrode body) and a pouch exterior body. More specifically, the pouch exterior body of the pouch-form rechargeable battery recited in JP-A No. 2020-64881 is structured by a first pouch portion and a second pouch portion, a first electrode lead is adhered to the first pouch portion, and a second electrode lead is adhered to the second pouch portion. In the pouch-form rechargeable battery recited in JP-A No. 2020-64881, the first electrode lead and second electrode lead are electrically connected by a film-form connection member. When the pouch exterior body swells due to overcharging or the like, the film-form connection member ruptures and charging is cut off.

However, in the structure recited in JP-A No. 2020-64881, rupturing the film-form connection member reliably when the pouch exterior body swells is difficult. Moreover, even at usual times when the pouch exterior body does not swell, the film-form connection member may be unintentionally ruptured by application of an external force.

### SUMMARY

The present disclosure provides a battery cell and battery module may suppress overcharging in a which in a case battery cell is abnormal.

A battery cell according to a first aspect includes: a laminate exterior body formed of a laminate containing a metal layer; an electrode body accommodated inside the laminate exterior body, in which electrode body a positive electrode and a negative electrode are laminated with one another sandwiching a separator; a pair of tabs that are connected with, respectively, the positive electrode and the negative electrode and that project outside the laminate exterior body; and a pair of conductive members that are electrically connected with the metal layer and disposed to be separated from the tabs, the conductive members respectively making contact with the pair of tabs in association with a swelling of the laminate exterior body.

In the battery cell according to the first aspect, the laminate exterior body is formed of the laminate including the metal layer, and the electrode body is accommodated inside the laminate exterior body. The tabs are connected to, respectively, the positive electrode and negative electrode constituting the electrode body. These tabs project to the outside of the laminate exterior body. Accordingly, the battery cell may be charged via the tabs.

The pair of conductive members that are disposed apart from the tabs are also provided. The pair of conductive members are each electrically connected with the metal layer of the laminate. In association with a swelling of the laminate exterior body, the pair of conductive members make contact with the respective tabs. Thus, at a time of swelling of the laminate exterior body, the tab at the positive electrode side and the tab at the negative electrode side short circuit via the metal layer, and overcharging may be inhibited. Then, when the laminate exterior body returns from the swollen state to its original state, the short-circuit state is disconnected.

In a battery cell according to a second aspect, in the first aspect, the laminate exterior body includes exposure portions at which the metal layer is exposed, and the pair of conductive members are joined to the metal layer at the exposure portions.

In the battery cell according to the second aspect, the exposed metal layer and the conductive members are joined and conduct electricity. Therefore, a component for connecting each conductive member with the metal layer is not necessary, and the pair of tabs may be put into states enabling a short circuit with a simple structure.

In a battery cell according to a third aspect, in the second aspect, the exposure portions are provided at locations that are not superposed with the tabs as seen in the lamination direction of the electrode body.

In the battery cell according to the third aspect, because each exposed portion is disposed at a location that is not superposed with the tab as seen in a lamination direction of the electrode body, unintended conduction between the tab and the metal layer may be suppressed.

In a battery cell according to a fourth aspect, in the first aspect, the conductive members are provided at locations that are not superposed with the electrode body as seen in the lamination direction of the electrode body.

In the battery cell according to the fourth aspect, each conductive member is provided at a location that is not superposed with the electrode body as seen in a lamination direction of the electrode body. Thus, the conductive member is disposed at a location where the cell is likely to swell, and the tab and conductive member are likely to make contact in association with a swelling of the cell.

In a battery cell according to a fifth aspect, in the first aspect, at least a portion of each conductive member is disposed at a location that is superposed with the corresponding tab as seen in the lamination direction of the electrode body.

In the battery cell according to the fifth aspect, because at least a portion of the conductive member is disposed at a location that is superposed with the tab as seen in a lamination direction of the electrode body, the tab and the conductive member are likely to make contact in association with a swelling of the cell.

In a battery cell according to a sixth aspect, in the first aspect, a whole of each tab is superposed with a corresponding conductive member as seen in a lamination direction of the electrode body.

In the battery cell according to the sixth aspect, because the whole of the tab is superposed with the conductive member as seen in the lamination direction of the electrode body, the tab and the conductive member more assuredly make contact in association with a swelling of the cell.

In a battery cell according to a seventh aspect, in the second aspect, each conductive member is joined to the metal layer at a joined portion and, seen in the lamination direction of the electrode body, one side of the conductive member sandwiching the joined portion is a tab-side contact portion that is capable of contact with a corresponding tab, and another side relative to the joined portion is a laminate-side contact portion.

In the battery cell according to the seventh aspect, as seen in the lamination direction of the electrode body, the conductive member is provided with the tab-side contact portion at one side and the laminate-side contact portion at the other side, sandwiching the joined portion at which the conductive member is joined to the metal layer. Thus, at a time of swelling of the laminate exterior body, the laminate-side contact portion and the tab-side contact portion move in opposite directions, pivoting about the joined portion, and the tab-side contact portion may be put into contact with the tab easily.

In a battery cell according to an eighth aspect, in the seventh aspect, the tab-side contact portion extends in a width direction of the tab by at least a width dimension of the tab.

In the battery cell according to the eighth aspect, at a time of swelling of the laminate exterior body, the tab-side contact portion may make contact with the whole of the width direction of the tab and may be reliably short-circuited.

In a battery cell according to a ninth aspect, in the eighth aspect, each conductive member includes a pair of bridging portions that connect between the tab-side contact portion and the laminate-side contact portion, and the pair of bridging portions are respectively joined to the metal layer at the exposure portions.

In the battery cell according to the ninth aspect, because the bridging portions are joined to the metal layer, even when a vibration, an external force or the like is applied, the joined state between the conductive member and the metal layer may be assuredly maintained. In addition, an action of the tab-side contact portion at a time of swelling of the laminate exterior body may be made more reliable than in a structure in which the conductive member and metal layer are joined at only one place.

In a battery module according to a tenth aspect, a plural number of the battery cell according to any one of the first and ninth aspects are accommodated in an arrayed state.

In the battery module according to the tenth aspect, of the plural battery cells, only an abnormal battery cell in which the laminate exterior body is swollen may be short-circuited.

In a battery module according to an eleventh aspect, in the tenth aspect, each tab is turned in a direction away from the corresponding conductive member.

In the battery module according to the eleventh aspect, because the tab is turned in the direction away from the conductive member, unintended contact between the conductive member and the tab at times of no swelling of the laminate exterior body may be suppressed.

As described above, according to the battery cell and battery module according to the present disclosure, overcharging may be reliably inhibited only at times of abnormality of the battery cell.

### BRIEF DESCRIPTION OF THE DRAWINGS

Exemplary embodiments of the present disclosure will be described in detail based on the following figures, wherein:

FIG. 1 is a schematic plan view showing principal portions of a vehicle in which a battery pack is employed.

FIG. 2 is a schematic perspective view of a battery module.

FIG. 3 is a plan view of a state in which an upper lid of the battery module is removed.

FIG. 4 is a schematic diagram in which a battery cell accommodated in the battery module is seen in a thickness direction.

FIG. 5 is a magnified principal portion view showing a magnification of principal portions of a battery cell according to a first exemplary embodiment.

FIG. 6 is a sectional diagram showing a state cut along line 6-6 in FIG. 5.

FIG. 7 is a schematic diagram, corresponding to FIG. 6, of when the battery cell is swollen.

FIG. 8 is a magnified principal portion view showing a magnification of principal portions of a battery cell according to a second exemplary embodiment.

FIG. 9 is a sectional diagram showing a state cut along line 9-9 in FIG. 8.

FIG. 10 is a sectional diagram, corresponding to FIG. 9, of when the battery cell is swollen.

### DETAILED DESCRIPTION

### First Exemplary Embodiment

A battery pack 10 that is equipped with a battery module 11 according to a first exemplary embodiment is described with reference to the drawings.

### Overall Structure of Vehicle 100

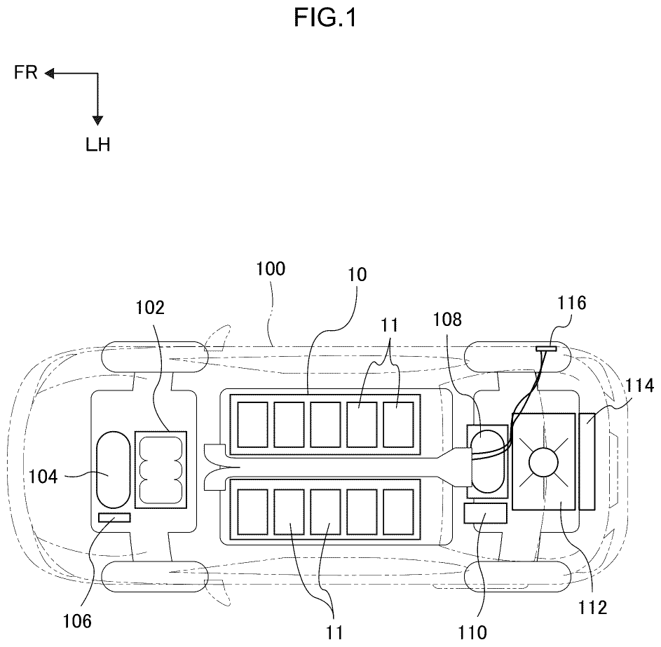

FIG. 1 is a schematic plan view showing principal portions of a vehicle 100 in which the battery pack 10 according to the exemplary embodiment is employed. As shown in FIG. 1, the vehicle 100 is a battery electric vehicle (BEV) in which the battery pack 10 is mounted under the floor. The arrow UP, arrow FR and arrow LH shown in the drawings indicate, respectively, the upper side in a vehicle vertical direction, the front side in a vehicle front-and-rear direction and the left side in a vehicle width direction. Below, where descriptions are given using directions to front and rear, left and right, and upper and lower, unless particularly specified these refer to front and rear in the vehicle front-and-rear direction, left and right in the vehicle width direction, and upper and lower in the vehicle vertical direction.

As an example in the vehicle 100 according to the present exemplary embodiment, a DC/DC converter 102, an electric compressor 104 and a positive temperature coefficient (PTC) heater 106 are disposed to the vehicle front side relative to the battery pack 10. A motor 108, a gearbox 110, an inverter 112 and a charger 114 are disposed to the vehicle rear side relative to the battery pack 10.

DC current outputted from the battery pack 10 is voltage-adjusted by the DC/DC converter 102 and supplied to the electric compressor 104, the PTC heater 106, the inverter 112 and so forth. Electric power is supplied to the motor 108 via the inverter 112. Thus, rear wheels are turned and the vehicle 100 runs.

A charging port 116 is provided at a right side portion of a rear portion of the vehicle 100. A charging plug of external charging equipment, which is not shown in the drawings, is connected through the charging port 116 and may cause electric power to accumulate in the battery pack 10 via the charger 114.

Arrangements, structures and the like of components structuring the vehicle 100 are not limited by the descriptions above. For example, a hybrid vehicle (HV) or plug-in hybrid electric vehicle (PHEV) in which an engine is mounted may be employed as the vehicle. In the present exemplary embodiment, the vehicle 100 is a rear wheel-drive vehicle in which the motor 108 is mounted in a vehicle rear portion, but this is not limiting. A front wheel-drive vehicle in which the motor 108 is mounted in a vehicle front portion is possible, and a vehicle in which a pair of the motor 108 are mounted at front and rear is also possible. A vehicle in which an in-wheel motor is provided at each wheel is also possible.

The battery pack 10 is structured with a plural number of the battery module 11. As an example in the present exemplary embodiment, ten of the battery modules 11 are provided. More specifically, five of the battery modules 11 are arrayed in the vehicle front-and-rear direction at the right side of the vehicle 100, and five of the battery modules 11 are arrayed in the vehicle front-and-rear direction at the left side of the vehicle 100. The respective battery modules 11 are electrically connected.

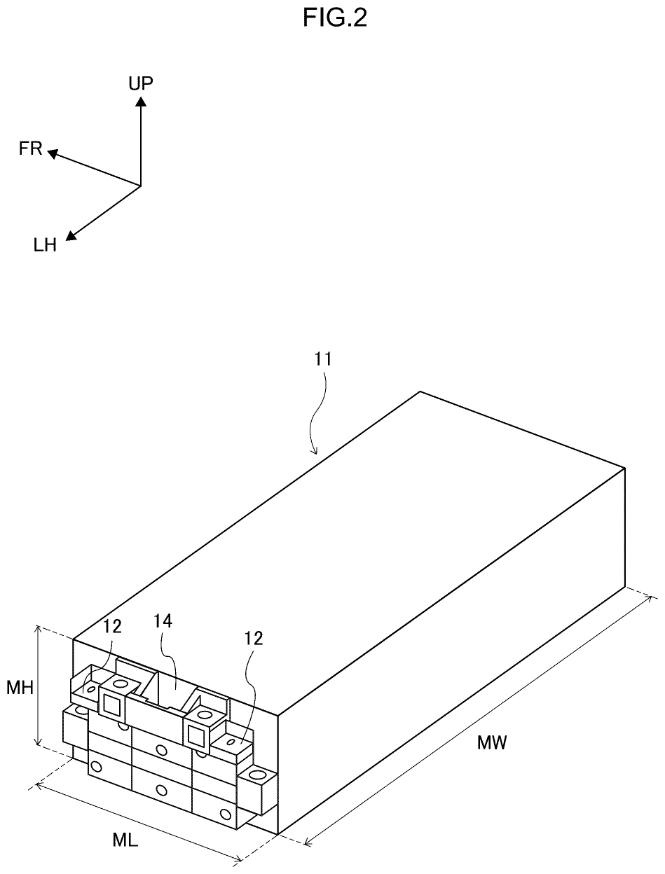

FIG. 2 is a schematic perspective view of the battery module 11. As shown in FIG. 2, each battery module 11 is formed in a substantially cuboid shape whose longest direction is in the vehicle width direction. An outer case of the battery module 11 is formed of an aluminium alloy. The outer case of the battery module 11 is formed by, for example, aluminium die-casts being joined, by laser welding or the like, to both end portions of an extruded aluminium alloy member.

A pair of voltage terminals 12 and a connector 14 are provided at each of the two vehicle width direction end portions of the battery module 11. A flexible printed circuit board (FPC) 21, which is described below, is connected to the connector 14. Bus bars, which are not shown in the drawings, are welded to the two vehicle width direction end portions of the battery module 11.

A length MW of the battery module 11 in the vehicle width direction is, for example, 350 to 600 mm, a length ML of the battery module 11 in the vehicle front-and-rear direction is, for example, 150 to 250 mm, and a length MH of the battery module 11 in the vehicle vertical direction is, for example, 80 to 110 mm.

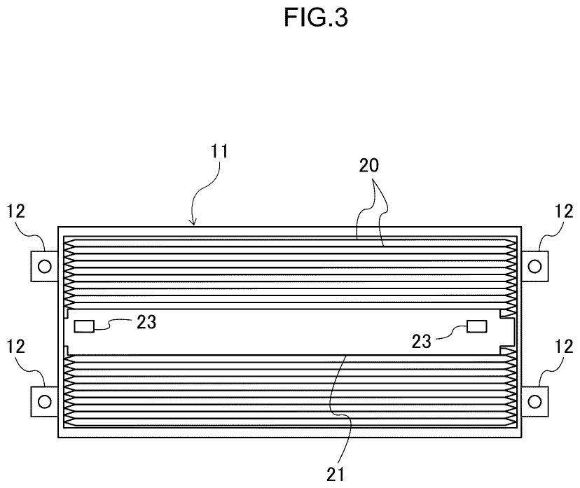

FIG. 3 is a plan view of a state in which an upper lid of the battery module 11 is removed. As shown in FIG. 3, plural battery cells 20 are accommodated inside the battery module 11 in an arrayed state. As an example in the present exemplary embodiment, 24 of the battery cells 20 are arrayed in the vehicle front-and-rear direction and adhered to one another.

The flexible printed circuit board 21 is disposed above the battery cells 20. The flexible printed circuit board 21 is formed in a strip shape whose length direction is in the vehicle width direction. A thermistor 23 is provided at each of two end portions of the flexible printed circuit board 21. Each thermistor 23 is not adhered to the battery cells 20 but is pressed toward the battery cells 20 by the upper lid of the battery module 11.

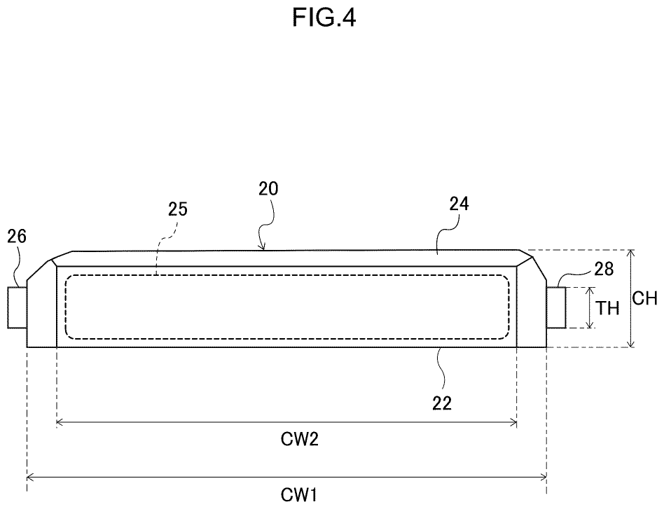

FIG. 4 is a schematic diagram in which one of the battery cells 20 accommodated in the battery module 11 is seen in a thickness direction thereof. As shown in FIG. 4, the battery cell 20 is formed substantially in a rectangular board shape, inside which an electrode body 25 is accommodated. The electrode body 25 is sealed in by a laminate exterior body 22 formed of a laminate material. For convenience of depiction, conductive members 30 and 32, which are principal portions of the present disclosure, are not shown in FIG. 4. Details of structure of end portions of the battery cell 20 including the conductive members 30 and 32 are described below.

As an example in the battery cell 20 according to the present exemplary embodiment, an accommodation portion for the electrode body is formed by the laminate exterior body 22, in an embossed sheet form, being folded over and stuck to itself. A single-cap embossed structure in which a single area is embossed or a double-cap embossed structure in which two areas are embossed may be employed. The present exemplary embodiment has a single-cap embossed structure with a stamping depth of around 8 to 10 mm.

Upper ends of both length direction end portions of the battery cell 20 are folded over, forming corners. An upper end portion of the battery cell 20 is folded over and a fixing tape 24 is wrapped round the upper end portion of the battery cell 20 along the length direction.

Respective tabs (terminals) are provided at both of length direction end portions of the battery cell 20. More specifically, a positive electrode-side tab 26 is provided at one length direction side of the battery cell 20 and a negative electrode-side tab 28 is provided at the other length direction side of the battery cell 20.

A vehicle width direction length CW1 of the battery cell 20 is, for example, 530 to 600 mm, a length CW2 of a region accommodating the electrode body is, for example, 500 to 520 mm, and a height CH of the battery cell 20 is, for example, 80 to 110 mm. A thickness of the battery cell 20 is 7.0 to 9.0 mm and a thickness TH of the terminals is 40 to 50 mm.

### Battery Cell 20

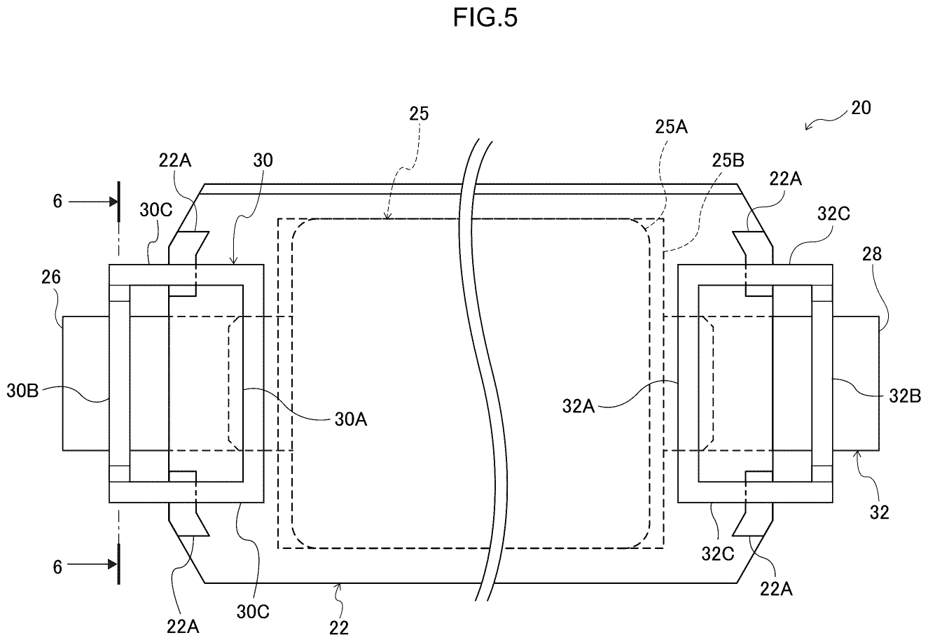

FIG. 5 is a magnified principal portion view showing a magnification of principal portions of the battery cell 20 according to the first exemplary embodiment. As illustrated in FIG. 5, the laminate exterior body 22 structuring the battery cell 20 according to the present exemplary embodiment is formed by coating a metal layer with resin. Exposure portions 22A, at which the metal layer is partially exposed, are provided at both length direction end portions of the laminate exterior body 22.

The exposure portions 22A are provided as pairs at the two length direction end portions of the laminate exterior body 22, at locations that are respectively offset up and down relative to the center of a short direction of the laminate exterior body 22 (the vertical direction). Thus, the exposure portions 22A are provided at locations that are not superposed with the positive electrode-side tab 26 and negative electrode-side tab 28 as seen in the lamination direction of the electrode body 25. Each exposure portion 22A is formed by, for example, exposing the metal layer by removing a resin layer of the laminate exterior body 22.

The electrode body 25 accommodated inside the laminate exterior body 22 is structured by a positive electrode 25A and a negative electrode 25B being laminated with one another, sandwiching a separator that is not shown in the drawings. In the present exemplary embodiment, the negative electrode 25B is slightly larger than the positive electrode 25A. When a battery module is formed, the positive electrode-side tab 26 is turned back to the opposite side from the side thereof at which the positive electrode-side conductive member 30 is disposed, and the negative electrode-side tab 28 is turned back to the opposite side from the side thereof at which the negative electrode-side conductive member 32 is disposed. More specifically, the positive electrode-side tab 26 is turned back in the lamination direction of the electrode body 25 to the further side of the drawing at the opposite side from the surface of the drawing at which the positive electrode-side conductive member 30 is provided, and the negative electrode-side tab 28 is turned back in the lamination direction of the electrode body 25 to the further side of the drawing at the opposite side from the surface of the drawing at which the negative electrode-side conductive member 32 is provided.

The positive electrode-side tab 26 is a metal plate formed in a substantially rectangular shape as seen in the lamination direction of the electrode body 25. One end portion of the positive electrode-side tab 26 is connected with an end portion of the positive electrode 25A inside the laminate exterior body 22. The other end portion of the positive electrode-side tab 26 projects outside the laminate exterior body 22.

The negative electrode-side tab 28 is a metal plate formed in a substantially rectangular shape as seen in the lamination direction of the electrode body 25. One end portion of the negative electrode-side tab 28 is connected with an end portion of the negative electrode 25B inside the laminate exterior body 22. The other end portion of the negative electrode-side tab 28 projects outside the laminate exterior body 22.

The positive electrode-side conductive member 30 is provided at a positive electrode side of the battery cell 20 and is formed in a substantially rectangular frame shape as seen in the lamination direction of the electrode body 25. More specifically, the positive electrode-side conductive member 30 is structured with a laminate-side contact portion 30A and a tab-side contact portion 30B. The laminate-side contact portion 30A extends over the laminate exterior body 22 in the short direction of the battery cell 20. The tab-side contact portion 30B is disposed above the positive electrode-side tab 26 and is substantially parallel with the laminate-side contact portion 30A. The positive electrode-side conductive member 30 is also provided with a pair of bridging portions 30C that extend in the length direction of the battery cell 20 and connect corresponding end portions of the laminate-side contact portion 30A and tab-side contact portion 30B with one another.

The laminate-side contact portion 30A of the positive electrode-side conductive member 30 is disposed at the side of an end portion of the battery cell 20 relative to the positive electrode 25A and negative electrode 25B of the electrode body 25. The laminate-side contact portion 30A is joined to a surface of the laminate exterior body 22 by adhesive, tape or the like. Thus, at a time of abnormality such as when a gas fills the interior of the laminate exterior body 22, the laminate-side contact portion 30A is displaced in association with a swelling of the laminate exterior body 22. Note, however, that the laminate-side contact portion 30A need not be joined to the laminate exterior body 22, in which case the laminate-side contact portion 30A would be displaced by being pushed out in association with a swelling of the laminate exterior body 22.

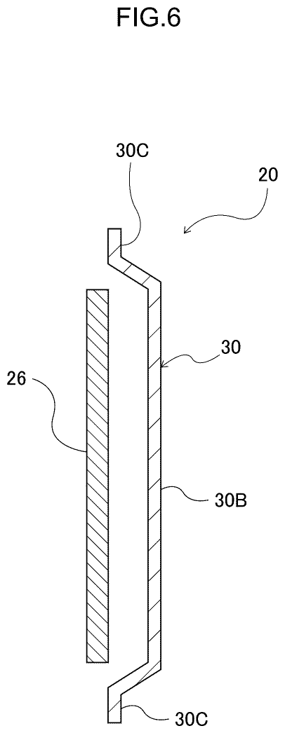

The tab-side contact portion 30B of the positive electrode-side conductive member 30 is disposed to be separated from the positive electrode-side tab 26 at usual times. The tab-side contact portion 30B extends by at least a width dimension of the positive electrode-side tab 26. As shown in FIG. 6, a cross-sectional shape of the tab-side contact portion 30B is formed substantially in a hat shape that is open to the side thereof at which the positive electrode-side tab 26 is disposed, which is a shape that circumvents the positive electrode-side tab 26.

As shown in FIG. 5, the pair of bridging portions 30C are in states of superposition with the exposure portions 22A and are joined to the metal layer of the laminate exterior body 22 at the exposure portions 22A. Joining between the bridging portions 30C and the metal layer is implemented by, for example, ultrasonic welding or the like.

In this way, the positive electrode-side conductive member 30 is electrically connected to the metal layer at the exposure portions 22A and is disposed to be separated from the positive electrode-side tab 26. Seen in the lamination direction of the electrode body 25, one side of the positive electrode-side conductive member 30 sandwiching joined portions at which the positive electrode-side conductive member 30 is joined to the metal layer serves as the tab-side contact portion 30B that is capable of contact with the positive electrode-side tab 26, and the other side relative to the joined portions serves as the laminate-side contact portion 30A, which is disposed at a location of the laminate exterior body 22 that is not superposed with the electrode body 25.

The tab-side contact portion 30B of this positive electrode-side conductive member 30 is structured so as to make contact with the positive electrode-side tab 26 in association with a swelling of the laminate exterior body 22. That is, at a time of swelling of the laminate exterior body 22, the laminate-side contact portion 30A is pushed out by the laminate exterior body 22 and displaced to the nearer side of the drawing of FIG. 5.

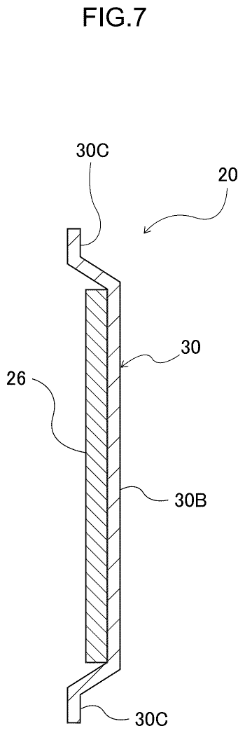

Because the exposure portions 22A are disposed at the end portion of the laminate exterior body 22 and are joined to the pair of bridging portions 30C, the exposure portions 22A do not swell, or swell by extremely little. Therefore, the tab-side contact portion 30B of the positive electrode-side conductive member 30 is displaced to the opposite side from the laminate-side contact portion 30A, that is, to the further side of the drawing of FIG. 5, pivoting about the exposure portions 22A. As a result, as shown in FIG. 7, the tab-side contact portion 30B makes contact with the positive electrode-side tab 26 and electricity is conducted between the positive electrode-side tab 26 and the metal layer at the exposure portions 22A.

Meanwhile, the negative electrode-side conductive member 32 is provided at the negative electrode side of the battery cell 20 and is formed in a shape symmetrical with the positive electrode-side conductive member 30. More specifically, the negative electrode-side conductive member 32 is structured with a laminate-side contact portion 32A and a tab-side contact portion 32B. The laminate-side contact portion 32A extends over the laminate exterior body 22 in the short direction of the battery cell 20. The tab-side contact portion 32B is disposed above the negative electrode-side tab 28 and is substantially parallel with the laminate-side contact portion 32A. The negative electrode-side conductive member 32 is also provided with a pair of bridging portions 32C that extend in the length direction of the battery cell 20 and connect corresponding end portions of the laminate-side contact portion 32A and tab-side contact portion 32B with one another.

The laminate-side contact portion 32A of the negative electrode-side conductive member 32 is disposed at the side at which an end portion of the battery cell 20 is disposed relative to the positive electrode 25A and negative electrode 25B of the electrode body 25. The laminate-side contact portion 32A is joined to a surface of the laminate exterior body 22 by adhesive, tape or the like. Thus, at a time of abnormality such as when a gas fills the interior of the laminate exterior body 22, the laminate-side contact portion 32A is displaced in association with the swelling of the laminate exterior body 22. Note, however, that the laminate-side contact portion 32A need not be joined to the laminate exterior body 22, in which case the laminate-side contact portion 32A would be displaced by being pushed out in association with a swelling of the laminate exterior body 22.

The tab-side contact portion 32B of the negative electrode-side conductive member 32 is disposed to be separated from the negative electrode-side tab 28 at usual times. The tab-side contact portion 32B extends by at least a width dimension of the negative electrode-side tab 28. A cross-sectional shape of the tab-side contact portion 32B is formed substantially in a hat shape similar to the positive electrode-side conductive member 30, which is a shape that circumvents the negative electrode-side tab 28.

The pair of bridging portions 32C are in states of superposition with the exposure portions 22A and are joined to the metal layer of the laminate exterior body 22 at the exposure portions 22A. Joining between the bridging portions 32C and the metal layer is implemented by, for example, ultrasonic welding or the like.

In this way, the negative electrode-side conductive member 32 is electrically connected to the metal layer at the exposure portions 22A and is disposed to be separated from the negative electrode-side tab 28. One side of the negative electrode-side conductive member 32 sandwiching joined portions at which the negative electrode-side conductive member 32 is joined to the metal layer serves as the tab-side contact portion 32B that is capable of contact with the negative electrode-side tab 28, and the other side relative to the joined portions serves as the laminate-side contact portion 32A, which is disposed at a location of the laminate exterior body 22 that is not superposed with the electrode body 25.

This tab-side contact portion 32B of the negative electrode-side conductive member 32 is structured so as to make contact with the negative electrode-side tab 28 in association with a swelling of the laminate exterior body 22. That is, at a time of swelling of the laminate exterior body 22, the laminate-side contact portion 32A is pushed out by the laminate exterior body 22 and displaced to the nearer side of the drawing of FIG. 5.

The tab-side contact portion 32B of the negative electrode-side conductive member 32 is displaced to the opposite side from the laminate-side contact portion 32A, that is, to the further side of the drawing of FIG. 5, pivoting about the exposure portions 22A. As a result, the tab-side contact portion 32B makes contact with the negative electrode-side tab 28 and electricity is conducted between the negative electrode-side tab 28 and the metal layer at the exposure portions 22A. Thus, a structure is formed such that the positive electrode-side tab 26 and negative electrode-side tab 28 are short-circuited at a time of swelling of the laminate exterior body 22, via the positive electrode-side conductive member 30, the negative electrode-side conductive member 32 and the metal layer.

### Operation

Now, operation of the battery cell 20 and battery module 11 according to the present exemplary embodiment is described.

In the battery cell 20 according to the present exemplary embodiment, the laminate exterior body 22 is formed of the laminate containing the metal layer, and the electrode body 25 is accommodated inside the laminate exterior body 22. The positive electrode-side tab 26 is connected to the positive electrode 25A structuring the electrode body 25, and the negative electrode-side tab 28 is connected to the negative electrode 25B. The positive electrode-side tab 26 and negative electrode-side tab 28 project outside the laminate exterior body 22. Thus, the battery cell may be charged via the positive electrode-side tab 26 and negative electrode-side tab 28.

The battery cell 20 is provided with the positive electrode-side conductive member 30 that is disposed apart from the positive electrode-side tab 26 and the negative electrode-side conductive member 32 that is disposed apart from the negative electrode-side tab 28. The positive electrode-side conductive member 30 and negative electrode-side conductive member 32 are each electrically connected to the metal layer of the laminate. In association with a swelling of the laminate exterior body 22, the positive electrode-side conductive member 30 makes contact with the positive electrode-side tab 26 and the negative electrode-side conductive member 32 makes contact with the negative electrode-side tab 28. Thus, the positive electrode-side tab 26 and negative electrode-side tab 28 short circuit and overcharging may be inhibited. When the laminate exterior body 22 returns from the swollen state to its original state, the short-circuit state is disconnected.

In the present exemplary embodiment, both the positive electrode-side conductive member 30 and the negative electrode-side conductive member 32 are joined to the metal layer at the exposure portions 22A and conduct electricity. Therefore, a component for connecting each conductive member with the metal layer is not necessary, and the positive electrode-side tab 26 and negative electrode-side tab 28 may be put into states enabling a short circuit with a simple structure.

In the present exemplary embodiment, because the exposure portions 22A are disposed at locations that are not superposed with the positive electrode-side tab 26 and negative electrode-side tab 28 as seen in the lamination direction of the electrode body 25, unintended conduction between these tabs and the metal layer may be suppressed.

Further in the present exemplary embodiment, the positive electrode-side conductive member 30 and negative electrode-side conductive member 32 are provided with the tab-side contact portions 30B and 32B at the one sides, sandwiching the joined portions at which the positive electrode-side conductive member 30 and negative electrode-side conductive member 32 are joined to the metal layer, and are provided with the laminate-side contact portions 30A and 32A at the other sides. Therefore, at a time of swelling of the laminate exterior body 22, the laminate-side contact portions 30A and 32A and the tab-side contact portions 30B and 32B move in opposite directions, pivoting about the joined portions, and the tab-side contact portions 30B and 32B may be put into contact with the positive electrode-side tab 26 and negative electrode-side tab 28 easily.

In the present exemplary embodiment, at a time of swelling of the laminate exterior body 22, the tab-side contact portion 30B may make contact with the whole of the width direction of the positive electrode-side tab 26 and the tab-side contact portion 32B may make contact with the whole of the width direction of the negative electrode-side tab 28. Therefore, the tab-side contact portions 30B and 32B may be reliably short-circuited.

In the present exemplary embodiment, because the pair of bridging portions 30C are joined to the metal layer, even when a vibration, an external force or the like is applied, the joined state between the positive electrode-side conductive member 30 and the metal layer may be assuredly maintained. Similarly, because the pair of bridging portions 32C are joined to the metal layer, even when a vibration, an external force or the like is applied, the joined state between the negative electrode-side conductive member 32 and the metal layer may be assuredly maintained. In addition, actions of the tab-side contact portions 30B and 32B at a time of swelling of the laminate exterior body 22 may be made more reliable than in a structure in which the positive electrode-side conductive member 30 and negative electrode-side conductive member 32 are each joined to the metal layer at only one place.

In the present exemplary embodiment, because the positive electrode-side tab 26 is turned in the direction away from the positive electrode-side conductive member 30, unintended contact between the positive electrode-side conductive member 30 and the positive electrode-side tab 26 at times of no swelling of the laminate exterior body 22 may be suppressed. Similarly, because the negative electrode-side tab 28 is turned in the direction away from the negative electrode-side conductive member 32, unintended contact between the negative electrode-side conductive member 32 and the negative electrode-side tab 28 at times of no swelling of the laminate exterior body 22 may be suppressed.

In the battery module 11 according to the present exemplary embodiment, the battery cells 20 according to the present exemplary embodiment are plurally accommodated in the arrayed state. Accordingly, of the plural battery cells 20, only an abnormal battery cell 20 in which the laminate exterior body 22 is swollen may be short-circuited, and the other, normal battery cells 20 may be charged.

### Second Exemplary Embodiment

Now, a battery cell 50 according to a second exemplary embodiment is described with reference to the drawings. Structures that are the same as in the first exemplary embodiment are assigned the same reference symbols and, as appropriate, are not described.

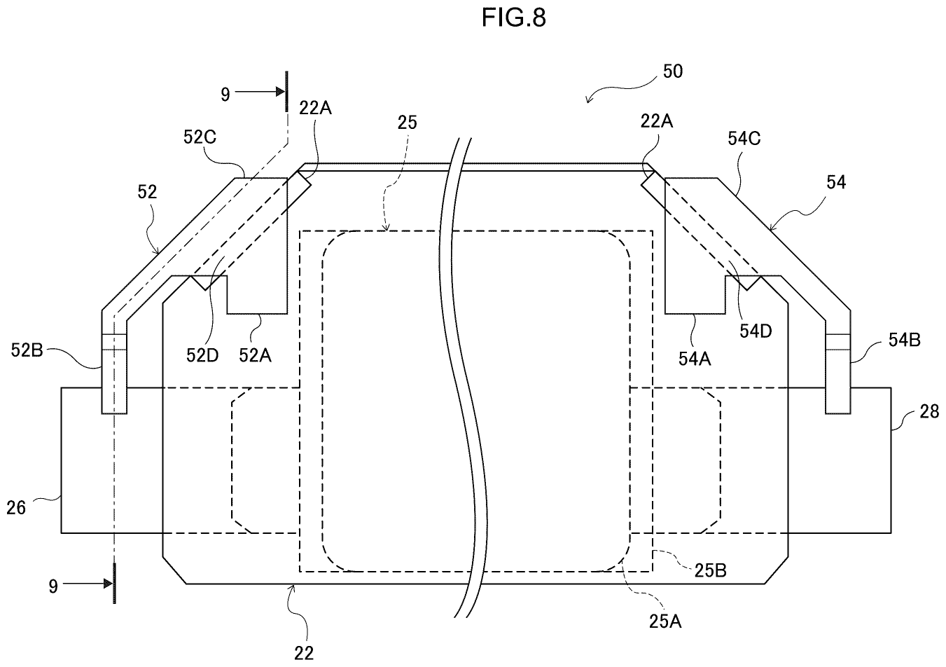

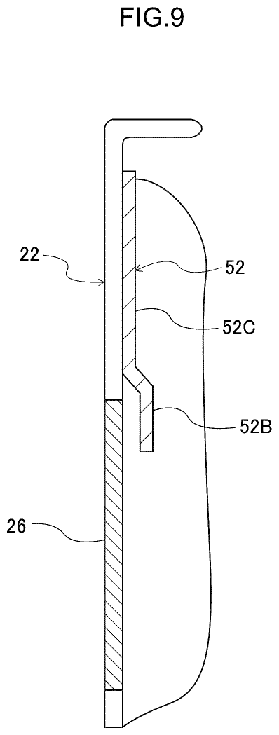

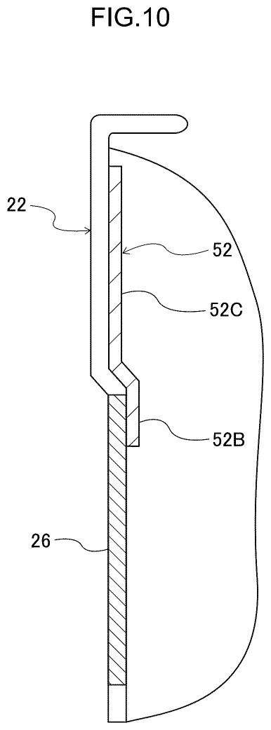

FIG. 8 is a magnified principal portion view showing a magnification of principal portions of the battery cell 50 according to the second exemplary embodiment. FIG. 9 is a sectional diagram showing a state cut along line 9-9 in FIG. 8. FIG. 10 is a sectional diagram, corresponding to FIG. 9, of when the battery cell 50 is swollen. As shown in FIG. 8, the laminate exterior body 22 structuring the battery cell 50 according to the present exemplary embodiment is formed by coating a metal layer with resin. The exposure portions 22A, at which the metal layer is partially exposed, are provided at both length direction end portions of the laminate exterior body 22.

The exposure portions 22A are provided at locations that are not superposed with the positive electrode-side tab 26 and negative electrode-side tab 28 as seen in the lamination direction of the electrode body 25. Each exposure portion 22A is formed by, for example, exposing the metal layer by removing a resin layer of the laminate exterior body 22.

The electrode body 25 accommodated inside the laminate exterior body 22 is structured by the positive electrode 25A and negative electrode 25B being laminated with one another, sandwiching a separator that is not shown in the drawings. In the present exemplary embodiment, the negative electrode 25B is slightly larger than the positive electrode 25A.

When a battery module is formed, the positive electrode-side tab 26 is turned back to the opposite side from the side thereof at which a positive electrode-side conductive member 52, which is described below, is disposed, and the negative electrode-side tab 28 is turned back to the opposite side from the side thereof at which a negative electrode-side conductive member 54, which is described below, is disposed. As an example in the present exemplary embodiment, the positive electrode-side tab 26 and negative electrode-side tab 28 are provided at portions of the battery cell 50 that are offset downward relative to the vertical direction center of the battery cell 50. The positive electrode-side tab 26 and negative electrode-side tab 28 are, for example, joined to bus bars, which are not shown in the drawings, by laser welding or the like.

The positive electrode-side conductive member 52 is structured with a laminate-side contact portion 52A, a tab-side contact portion 52B and a connecting portion 52C. The laminate-side contact portion 52A is disposed over the laminate exterior body 22 at a location that is not superposed with the electrode body 25, and is joined to a surface of the laminate exterior body 22 by adhesive, tape or the like. Thus, at a time of abnormality such as when a gas fills the interior of the laminate exterior body 22, the laminate-side contact portion 52A is displaced in association with a swelling of the laminate exterior body 22.

The tab-side contact portion 52B is disposed upward of the positive electrode-side tab 26 at the outer side relative to the laminate exterior body 22. As illustrated in FIG. 9, the tab-side contact portion 52B is turned back relative to the connecting portion 52C in the direction away from the positive electrode-side tab 26, forming a shape that suppresses unintended contact between the positive electrode-side conductive member 52 and the positive electrode-side tab 26 at times of no swelling of the laminate exterior body 22.

As shown in FIG. 8, the connecting portion 52C connects the laminate-side contact portion 52A with the tab-side contact portion 52B. A portion of the connecting portion 54C is a joined portion 54D that is superposed with the exposure portion 22A and joined to the exposure portion 22A. Accordingly, one side of the positive electrode-side conductive member 52 relative to the joined portion 52D serves as the tab-side contact portion 52B, and the other side relative to the joined portion 52D serves as the laminate-side contact portion 52A.

The negative electrode-side conductive member 54 has substantially the same shape as the positive electrode-side conductive member 52 and is arranged with left-and-right symmetry with the positive electrode-side conductive member 52. The negative electrode-side conductive member 54 is structured with a laminate-side contact portion 54A, a tab-side contact portion 54B and a connecting portion 54C. The laminate-side contact portion 54A is disposed over the laminate exterior body 22 at a location that is not superposed with the electrode body 25, and is joined to the surface of the laminate exterior body 22 by adhesive, tape or the like. Thus, at a time of abnormality such as when a gas fills the interior of the laminate exterior body 22, the laminate-side contact portion 54A is displaced in association with the swelling of the laminate exterior body 22.

The tab-side contact portion 54B is disposed upward of the negative electrode-side tab 28 at the outer side relative to the laminate exterior body 22. Similarly to the tab-side contact portion 52B of the positive electrode-side conductive member 52, the tab-side contact portion 54B is turned back relative to the connecting portion 54C in the direction away from the negative electrode-side tab 28, forming a shape that suppresses unintended contact between the negative electrode-side conductive member 54 and the positive electrode-side tab 26 at times of no swelling of the laminate exterior body 22.

As shown in FIG. 8, the connecting portion 54C connects the laminate-side contact portion 54A with the tab-side contact portion 54B. A portion of the connecting portion 54C is a joined portion 54D that is superposed with the exposure portion 22A and joined to the exposure portion 22A. Accordingly, one side of the negative electrode-side conductive member 54 relative to the joined portion 54D serves as the tab-side contact portion 54B, and the other side relative to the joined portion 54D serves as the laminate-side contact portion 54A.

The positive electrode-side conductive member 52 and negative electrode-side conductive member 54 are structured as described above. Thus, at a time of swelling of the laminate exterior body 22, the laminate-side contact portion 52A of the positive electrode-side conductive member 52 and the laminate-side contact portion 54A of the negative electrode-side conductive member 54 are pushed out by the laminate exterior body 22 and displaced to the nearer side of the drawing of FIG. 8.

The tab-side contact portion 52B of the positive electrode-side conductive member 52 and the tab-side contact portion 54B of the negative electrode-side conductive member 54 are displaced to the opposite sides from the laminate-side contact portion 52A and laminate-side contact portion 54A, that is, to the further side of the drawing of FIG. 8, pivoting about the exposure portions 22A. As a result, as shown in FIG. 10, the tab-side contact portion 52B of the positive electrode-side conductive member 52 makes contact with the positive electrode-side tab 26 and electricity is conducted between the positive electrode-side tab 26 and the metal layer at the exposure portion 22A.

Similarly to the tab-side contact portion 52B, the tab-side contact portion 54B of the negative electrode-side conductive member 54 makes contact with the negative electrode-side tab 28 and electricity is conducted between the negative electrode-side tab 28 and the metal layer of the exposure portion 22A. Thus, a structure is formed such that the positive electrode-side tab 26 and negative electrode-side tab 28 are short-circuited at a time of swelling of the laminate exterior body 22, via the positive electrode-side conductive member 52, the negative electrode-side conductive member 54 and the metal layer.

### Conductive Members

Shapes of the conductive members are not limited to the shapes illustrated in the first exemplary embodiment and the second exemplary embodiment. For example, rectangular shapes, circular shapes, trapezoid shapes, triangular shapes and so forth can be mentioned as shapes of the conductive members.

### Operation

Now, operation of the battery cell 50 according to the present exemplary embodiment is described.

In the battery cell 50 according to the present exemplary embodiment, the positive electrode-side tab 26 and negative electrode-side tab 28 may be short-circuited by a simpler structure than in the first exemplary embodiment. Other operations are similar to the first exemplary embodiment.

The battery cell 20 and battery module 11 are described above in accordance with the present exemplary embodiments but are not limited thus. It will be clear that numerous embodiments are possible within a scope not departing from the gist of the present disclosure. In the exemplary embodiments described above, the positive electrode-side conductive member 30 and the metal layer are joined at the exposure portions 22A but this is not limiting. For example, rather than the exposure portions 22A being provided at the laminate exterior body 22, terminals may project outside the laminate exterior body 22 from the metal layer, and the positive electrode-side conductive member 30 may be joined to these terminals.

The following additional notes are disclosed in relation to the exemplary embodiments described above.

### Additional Note 1

A battery cell includes:
a laminate exterior body formed of a laminate containing a metal layer;
an electrode body accommodated inside the laminate exterior body, in which electrode body a positive electrode and a negative electrode are laminated with one another sandwiching a separator;
a pair of tabs that are connected with, respectively, the positive electrode and the negative electrode and that project outside the laminate exterior body; and
a pair of conductive members that are electrically connected with the metal layer and disposed to be separated from the tabs, the conductive members respectively making contact with the pair of tabs in association with a swelling of the laminate exterior body.

### Additional Note 2

The battery cell according to additional note 1, in which the laminate exterior body includes exposure portions at which the metal layer is exposed, and the pair of conductive members are joined to the metal layer at the exposure portions.

### Additional Note 3

The battery cell according to additional note 2, in which the exposure portions are provided at locations that are not superposed with the tabs as seen in the lamination direction of the electrode body.

### Additional Note 4

The battery cell according to any one of additional notes 1 to 3, in which the conductive members are provided at locations that are not superposed with the electrode body as seen in the lamination direction of the electrode body.

### Additional Note 5

The battery cell according to any one of additional notes 1 to 4, in which at least a portion of each conductive member is disposed at a location that is superposed with the corresponding tab as seen in the lamination direction of the electrode body.

### Additional Note 6

The battery cell according to any one of additional notes 1 to 4, in which the whole of each tab is superposed with the corresponding conductive member as seen in the lamination direction of the electrode body.

### Additional Note 7

The battery cell according to additional note 2, in which
each conductive member is joined to the metal layer at a joined portion and,
seen in the lamination direction of the electrode body, one side of the conductive member sandwiching the joined portion is a tab-side contact portion that is capable of contact with the corresponding tab, and the other side relative to the joined portion is a laminate-side contact portion.

### Additional Note 8

The battery cell according to additional note 7, in which the tab-side contact portion extends in a width direction of the tab by at least a width dimension of the tab.

### Additional Note 9

The battery cell according to additional note 8, in which
the each conductive member includes a pair of bridging portions that connect between the tab-side contact portion and the laminate-side contact portion, and
the pair of bridging portions are respectively joined to the metal layer at the exposure portions.

### Additional Remarks 10

A battery module in which a plural number of the battery cell recited in any one of additional notes 1 to 9 are accommodated in an arrayed state.

### Additional Remarks 11

The battery module according to additional note 10, in which each tab is turned in a direction away from the corresponding conductive member.

What is claimed is:

1. A battery cell comprising:
a laminate exterior body formed of a laminate containing a metal layer;
an electrode body accommodated inside the laminate exterior body, in which electrode body a positive electrode and a negative electrode are laminated with one another sandwiching a separator;
a pair of tabs that are connected with, respectively, the positive electrode and the negative electrode and that project outside the laminate exterior body; and
a pair of conductive members that are electrically connected with the metal layer and disposed to be separated from the tabs, the conductive members respectively making contact with the pair of tabs in association with a swelling of the laminate exterior body.

2. The battery cell according to claim 1, wherein the laminate exterior body includes exposure portions at which the metal layer is exposed, and the pair of conductive members are joined to the metal layer at the exposure portions.

3. The battery cell according to claim 2, wherein the exposure portions are provided at locations that are not superposed with the tabs as seen in a lamination direction of the electrode body.

4. The battery cell according to claim 1, wherein the conductive members are provided at locations that are not superposed with the electrode body as seen in a lamination direction of the electrode body.

5. The battery cell according to claim 1, wherein at least a portion of each conductive member is disposed at a location that is superposed with a corresponding tab as seen in a lamination direction of the electrode body.

6. The battery cell according to claim 1, wherein a whole of each tab is superposed with a corresponding conductive member as seen in a lamination direction of the electrode body.

7. The battery cell according to claim 2, wherein:
each conductive member is joined to the metal layer at a joined portion, and seen in a lamination direction of the electrode body, one side of the conductive member sandwiching the joined portion is a tab-side contact portion that is capable of contact with a corresponding tab, and another side relative to the joined portion is a laminate-side contact portion.

8. The battery cell according to claim 7, wherein the tab-side contact portion extends in a width direction of the tab by at least a width dimension of the tab.

9. The battery cell according to claim 8, wherein:
each conductive member includes a pair of bridging portions that connect between the tab-side contact portion and the laminate-side contact portion, and
the pair of bridging portions are respectively joined to the metal layer at the exposure portions.

10. A battery module in which a plurality of battery cells according to claim 1 is accommodated in an arrayed state.

11. The battery module according to claim 10, wherein each tab is turned in a direction away from a corresponding conductive member.
